(19) United States
(12) Patent Application Publication
(10) Pub. No.: US 2010/0211311 A1
(43) Pub. Date: Aug. 19, 2010

(54) Method for Updating Map Data of a Navigation Device and Related Device

(76) Inventor: Chuan-Cheng Fu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/684,114

(22) Filed: Jan. 8, 2010

(30) Foreign Application Priority Data
Feb. 13, 2009 (TW) 098104648

(51) Int. Cl. G01C 21/00; G06F 3/041; G10L 15/26

(52) U.S. Cl. 701/208; 345/173; 704/235; 704/E15.043

(57) ABSTRACT

A method for updating map data of a navigation device includes forming a keypad, and recording information of a current position of the navigation device when the keypad is triggered.

### BACKGROUND OF THE INVENTION

1. Field of the Invention

The present invention is related to a method for updating map data of a navigation device and related updating device and navigation device, and more particularly, to a method and related updating device and navigation device capable of quickly, conveniently and safely updating map data.

2. Description of the Prior Art

With the advancement of technology, a personal navigation device (PND) becomes popular in the market, and is widely used by consumers. In general, on the basis of existed map data, the PND performs route plan, navigation, etc. according to user requirements, so that the user can efficiently reach a demanded destination.

Using the PND, the user can correctly and efficiently reach the destination, even an unknown spot, to save time and avoid getting lost. In addition, in order to enhance reliability of map data, the prior art PND typically updates the stored map data via a certain medium, such as internet, CD, memory card, etc., so as to perform navigation according to the latest roadway information. Meanwhile, the user can further manually add a new POI (Point of Interest) or coordinate, such as “Home”, “Office”, etc. However, in the prior art PND, when adding the new POI or coordinate, the user has no alternative but to go through a complex operating process including, for example, opening multi-layer menus first, setting to add a current coordinate or a specified coordinate into the map data, entering corresponding coordinate information by handwriting or other input methods, and finally, storing the information. Apparently, such process is complex and inefficient, causing the user hard to add the new POI or coordinate into the map data. Therefore, if the user discovers a new POI and wants to add the new POI into the map data for further searches while driving, the user has to stop and park the car, to input information of the POI into PND, or ask someone else to do so. Obviously, such an operating method is extremely inconvenient, and thus, corresponding improvement is required.

### SUMMARY OF THE INVENTION

It is therefore a primary objective of the claimed invention to provide a method for updating map data of a navigation device and related updating device and navigation device.

The present invention discloses a method for updating map data of a navigation device, which comprises forming a keypad, and recording information of a current position of the navigation device when the keypad is triggered.

The present invention further discloses an updating device for updating map data of a navigation device, which comprises a keypad, and a recording unit, for recording information of a current position of the navigation device when the keypad is triggered.

The present invention further discloses a navigation device, which comprises a display device, a positioning device, for acquiring coordinate information corresponding to a current position according to a global positioning system, a database, for storing map data, a navigation processor, coupled to the display device, the positioning device and the database, for displaying navigation results on the display device according to the coordinate information, and an updating device. The updating device comprises a keypad, and a recording unit, for recording information of the current position in the database when the keypad is triggered. The information comprises the coordinate information of the current position.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a navigation device according to an embodiment of the present invention.

FIG. 2 is a schematic diagram of an updating device shown in FIG. 1 according to an alternative embodiment of the present invention.

FIG. 3 is a schematic diagram of a process for updating map data according to an embodiment of the present invention.

### DETAILED DESCRIPTION

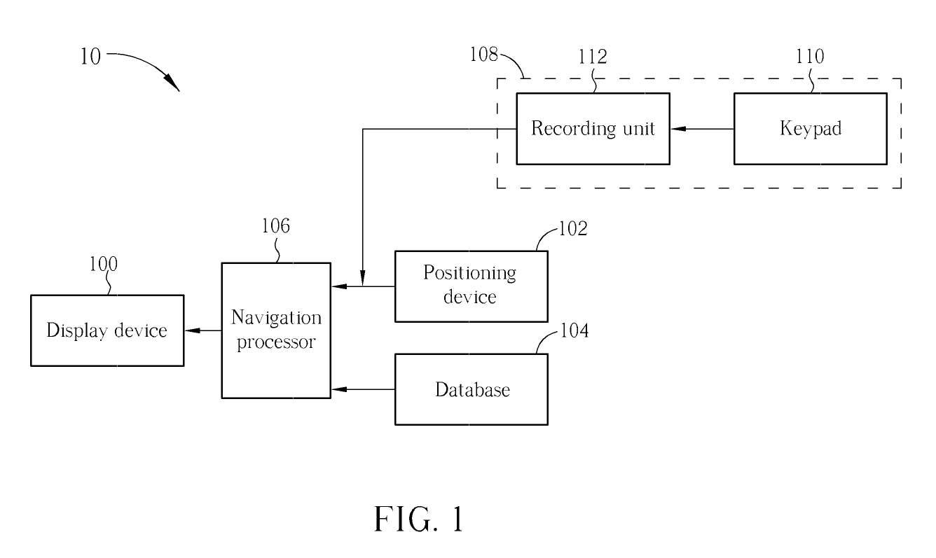

Please refer to FIG. 1, which is a schematic diagram of a navigation device 10 according to an embodiment of the present invention. The navigation device 10 comprises a display device 100, a positioning device 102, a database 104, a navigation processor 106 and an updating device 108. The positioning device 102 can be a positioning device of Global Positioning System (GPS) or other positioning systems, and is utilized for acquiring coordinate information of a current position. The database 104 is utilized for storing map data. The navigation processor 106 is utilized for displaying navigation results on the display device 100 according to the coordinate information acquired by the positioning device 102. In addition, the updating device 108 comprises a keypad 110 and a recording unit 112, and is utilized for timely recording information of the current position. When the display device 100 is implemented by a touch screen, the keypad 110 can be an image, an object, etc. on the touch screen. Or, the keypad 110 can be a physical keypad formed on a case of the navigation device 10 (not shown in FIG. 1). The recording unit 112 is utilized for recording the coordinate and other related information of the current position in the database 104 when the keypad 110 is triggered.

Therefore, via the updating device 108, when a user presses the keypad 110, the recording unit 112 can record the coordinate and related information of the current position in the database 104. In other words, if the user discovers a special or fascinating POI (Point of Interest) while driving, the user can press the keypad 110 to trigger the updating device 108 to record information of POI in the database 104 for further searches. As a result, the user does not need to stop the car to perform complex operations, but to press the keypad 110, so as to record the information of the current position in the updating device 108.

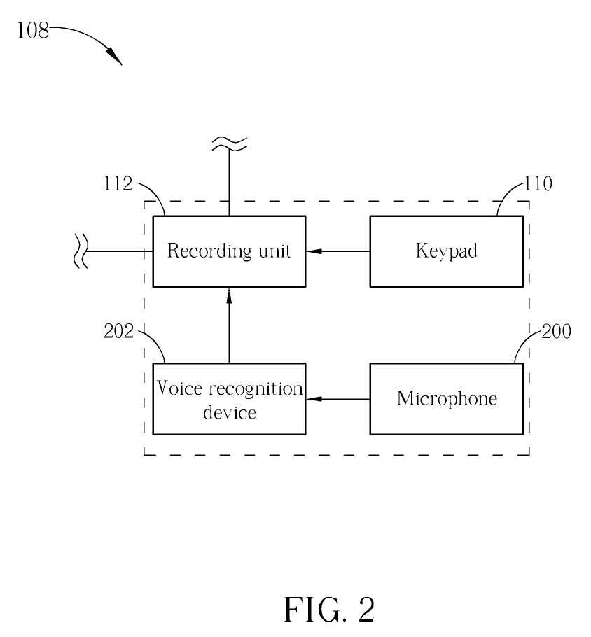

Note that, the navigation device 10 illustrated in FIG. 1 is a schematic diagram of the embodiment of the present invention, and certainly, those skilled in the art can make variations and modifications accordingly. For example, except recording the coordinate information of the current position in the database 104, the recording unit 112 can further store a documentation file corresponding to the current position in the database 104. Preferably, the content of the documentation file is created by the user, and utilized for describing features of the current position, such as “century-old shop”, “historic spot”, etc. In such a situation, except manual input, the present invention can preferably transform a voice signal of the user into text by a voice recognition method, to generate the documentation file of the current position. For example, please refer to FIG. 2, which is a schematic diagram of the updating device updating 108 in FIG. 1 according to an alternative embodiment of the present invention. In FIG. 2, the updating device 108 further comprises a microphone 200 and a voice recognition device 202. The microphone 200 is utilized for acquiring voice signals of the user, and the voice recognition device 202 is utilized for transforming the voice signals into corresponding text, such that the recording unit 112 can record the documentation file of the current position in the database 104.

Therefore, using the updating device 108 shown in FIG. 2, the user can generate the documentation file of the current position by oral report, so as to enhance utilization convenience and safety. For instance, if the user discovers a special or fascinating POI while driving, the user can press the keypad 110 to trigger the updating device 108 to record the information of POI in the database 104; meanwhile, the user can speak out or read a feature, name, or other information of POI, so that the voice recognition device 202 can recognize the corresponding text, and thereby store the corresponding text in the database 104 by the recording unit 112. In such a situation, the user does not need to stop the car to perform complex operations, but to press the keypad 110, so as to record the information of the current position in the updating device 108 for future searches.

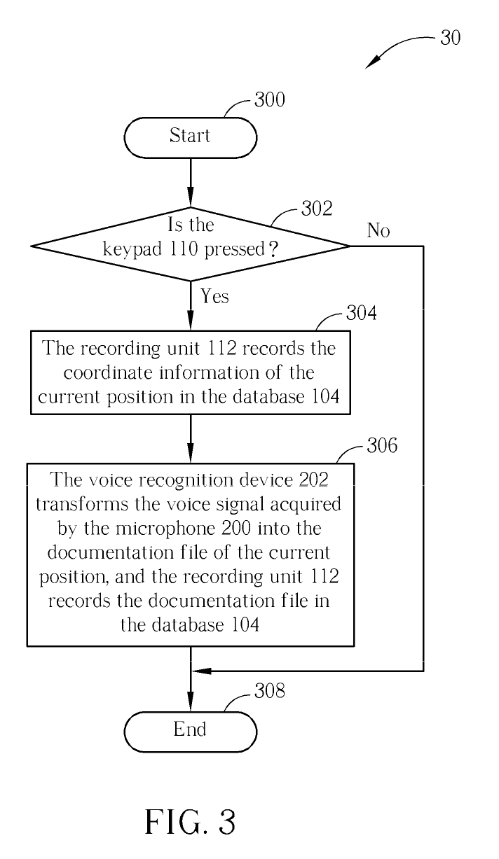

With respect to the updating device 108, operations thereof can be further summarized to an updating process 30, as illustrated in FIG. 3. The updating process 30 includes the following steps:

Step 300: Start.

Step 302: Determine whether the keypad 110 is triggered. If yes, proceed to Step 304; else, proceed to Step 308.

Step 304: The recording unit 112 records the coordinate information of the current position in the database 104.

Step 306: The voice recognition device 202 transforms the voice signal acquired by the microphone 200 into the documentation file of the current position, and the recording unit 112 thereby records the documentation file in the database 104.

Step 308: End.

The updating process 30 is utilized for summarizing the operations of the updating device 108. Detailed description thereof can be referred in the above and not given herein for the sake of brevity.

In the prior art, when manually adding a new POI or coordinate, the user has no alternative but to go through a complex operating process, causing the user hard to add the new POI or coordinate into the map data. In comparison, the present invention records related information of the new POI as the user presses the keypad 110, which is fast, convenient and safe.

In addition, the present invention can further include a setting unit to set whether to enable functions corresponding to the keypad 110, e.g. navigation, voice reception, etc., which is not related to the present invention, and not given herein.

To sum up, via the present invention, when the user wants to add a new POI or coordinate, the coordinate information of the current position and the corresponding documentation file are recorded as the user presses the keypad. Such an operation is fast, convenient and safe.

Those skilled in the art will readily observe that numerous modifications and alterations of the device and method may be made while retaining the teachings of the invention.

What is claimed is:

1. A method for updating map data of a navigation device comprising:
forming a keypad; and
recording information of a current position of the navigation device when the keypad is triggered.

2. The method of claim 1, wherein forming the keypad is displaying an image on a touch screen of the navigation device, to form the keypad.

3. The method of claim 1, wherein forming the keypad is forming the keypad on a case of the navigation device.

4. The method of claim 1, wherein the information of the current position comprises coordinate information corresponding to the current position according to a global positioning system.

5. The method of claim 4, wherein the information of the current position further comprises a documentation file corresponding to the current position.

6. The method of claim 5 further comprising:
acquiring a voice signal; and
transforming the voice signal into corresponding text, to generate the documentation file.

7. An updating device for updating map data of a navigation device comprising:
a keypad; and
a recording unit, for recording information of a current position of the navigation device when the keypad is triggered.

8. The updating device of claim 7, wherein the keypad is an image on a touch screen of the navigation device.

9. The updating device of claim 7, wherein the keypad is formed on a case of the navigation device.

10. The updating device of claim 7, wherein the information of the current position comprises coordinate information corresponding to the current position according to a global positioning system.

11. The updating device of claim 10, wherein the information of the current position further comprises a documentation file corresponding to the current position.

12. The updating device of claim 11 further comprising:
a microphone, for acquiring a voice signal; and
a voice recognition device, for transforming the voice signal into corresponding text, to generate the documentation file.

13. A navigation device comprising:
a display device;
a positioning device, for acquiring coordinate information corresponding to a current position according to a global positioning system;
a database, for storing map data;
a navigation processor, coupled to the display device, the positioning device and the database, for displaying navigation results on the display device according to the coordinate information; and
an updating device, comprising:
a keypad; and
a recording unit, for recording information of the current position in the database when the keypad is triggered, the information comprising the coordinate information of the current position.

14. The navigation device of claim 13, wherein the display device is a touch screen, and the keypad is an image on the touch screen.

15. The navigation device of claim 13, wherein the keypad is formed on a case of the navigation device.

16. The navigation device of claim 13, wherein the information of the current position further comprises a documentation file corresponding to the current position.

17. The navigation device of claim 16, wherein the updating device further comprises:
a microphone, for acquiring a voice signal; and
a voice recognition device, for transforming the voice signal into corresponding text, to generate the documentation file.

18. The navigation device of claim 13 further comprising a setting unit, for enabling functions of the keypad.

19. The navigation device of claim 18, wherein the setting unit is further utilized for setting the functions corresponding to the keypad.
